(19) United States
(12) Patent Application Publication
(10) Pub. No.: US 2002/0121162 A1
(43) Pub. Date: Sep. 5, 2002

(54) Pipe wrench

(76) Inventor: Zhigang Dong, Beijing (CN)

Correspondence Address: PALMER & DODGE, LLP, KATHLEEN M. WILLIAMS, 111 HUNTINGTON AVENUE, BOSTON, MA, 02199, US

(21) Appl. No.: 10/096,097

(22) Filed: Mar. 12, 2002

Related U.S. Application Data
(63) Continuation of application No. PCT/SG00/00146, filed on Sep. 13, 2000.

(30) Foreign Application Priority Data
Sep. 13, 1999 (CN) ZL 99 2 44513.2
Sep. 8, 2000 (CN) 00124337.3

(51) Int. Cl. B25B 13/28

(52) U.S. Cl. 81/99

(57) ABSTRACT

A Pipe Wrench with: reasonable coordination on distance between-Center of Arcuate Teeth and Link-Hole, eccentric length of Tips of Arcuate Teeth and Link-Hole; Instant Grip and Release, Time-Saving, Power-Saving, easy Operation is disclosed. It is composed of Heading-Hook, Main Body, Arcuate Jaw-Block, Spring-Guard Plate, Spring, Oil-Rope, Pin and Screw Bolt. The Jaw-Block designed by two (2) different sizes of Arc is inlaid in Slot B on Handle, due to designed size of Link-Hole being eccentric from center of Arcs of Jaw-Block is well coordinated with Arcs on Tip Teeth of Jaw-Block, which enables this Invention with Reliable and Firm Self-Lock on workpiece as well as its Open-Width being enlarged.

### FIELD OF INVENTION

This invention relates to a kind of hand tool with a function of gripping and clamping.

### BACKGROUND

Common Pipe Wrench is made with Leading Screw and Screw Nut, the adjustment of its opening and closing is realized by coordination between these two (2) parts, continuous regulating is needed being operated, waste time and manpower, the workpiece is easily damaged, due to its device; in addition, causing non-average pressure on workpiece and slippage. The existing Pipe Wrench has also function of 3-pointed contact on workpiece, but its Operating Open-Width does not come up to the requirement being operated, resulted from irrational device on the distance between Heading-Hook and Top-Teeth of Arcuate Jaw-Block and the distance between the Centers of Arc of Jaw-Block Teeth-Tips+Heading-Hook teeth-Tips and Pin Hole, leading to inconvenience to operation.

The aim of this invention is to avoid above mentioned inadequateness, supplying a sort of Pipe Wrench with good performance, larger size of Operating Open-Width, reliable gripping, instant locking, manpower-save, convenient operation that resulted from reasonable design in coordination of the distance between center of Arcuate Teeth and Linking Hole, eccentric distance between Tip of Arcuate Teeth and Link-Hole.

### SUMMARY

In accordance with an aspect of the invention, A Pipe Wrench is provided, which comprises: Heading-Hook; Main Body; Arcuate Jaw-Block; Spring-Guard Plate; Spring; Oil-Rope; Pin; and Screw Bolt, wherein the Jaw-Block formed by two (2) different Arcs on its top Face is inlaid in Slot B on Main Body, the Horizontal Line P on top of Arcuate Jaw-Block has a distance of 20 mm˜50 mm away from Horizontal Central Line 0 of Link-Hole A; the st. Arcuate Line from Point C˜Point, and 2^{nd} Arcuate Line from Point D˜Point E that connected with 1st. Arcuate Line, Vertical Extended Line of Central Point F of 1^{st}. Arcuate Line of Jaw-Block is away from Central Line O of Link-Hole A for a distance of 8 mm˜65 mm, Central Point F of 1^{st}. Arcuate Line on Jaw-Block has a distance of 10 mm 43 mm away horizontally from Vertical Extended Line Q of the Center of Link-Hole, wherein the distance between Vertical Extended Line of Central Point m—the center of 2^{nd}. Arcuate line of Jaw-Block being connected with 1^{st}. Arcuate Line from Point D˜Point E and Horizontal Central Line O of Link-Hole A is for a distance of 2 mm˜33 mm, the Horizontal Line N of Point m—the Center of 2^{nd}. Arcuate Line being connected with 1^{st}. Arcuate Line from Point D˜Point F is apart from Vertical Extended Central Line Q of Link-Hole for a distance of 16 mm˜62 mm; the horizontal Line G is away from Central Line O of Link-Hole A for a distance of 26 mm˜58 mm.

### Brief Description of Drawing

Embodiments of the invention are described with reference to the following drawing, in which:

FIGS. 1a and 1b show the structure of a Pipe Wrench with hidden views, the Pipe Wrench according to an embodiment of the invention; and

FIG. 2 shows the structure of a part of the Pipe Wrench of FIG. 1a.

### DETAILED DESCRIPTION

To actualize abovementioned aim, a Pipe Wrench according to embodiments of the, invention is designed as a V-Typed Heading-Hook with teeth arrayed on its inboard face, the angle of V Typed Heading-Hook is between 110°˜125° and laid into/between the Link Position of the Main Body, a Pin is inserted into Link-Hole A, the Jaw-Block formed by two (2) different Arcuate Lines is inlaid into Slot B of the Main Body, the distance between Horizontal Line P of Teeth-Tips of Jaw-Block and Central Horizontal Line O of Link-Hole A is 2 mm˜50 mm, the angle of 1^{st}. Arcuate Line from Point C˜Point D of the Jaw-Block is R30 mm-R120 mm, the angle of 2^{nd}. Arcuate Line connected with Ist, Arcuate Line from Point D˜Point E is R20 mm˜R90 mm; the distance between Extended Line S being vertical to Central Point F of 1^{st}. Arcuate Line of Jaw-Block and Central Line O of Link-Hole A is 8 mm˜65 mm, the Center F of 1^{st}. Arc of Jaw-Block crossed to the Extended Central Line Q of Link-Hole A with a distance scope of 10 mm˜43 mm, the Extended Central Line of Center m of Arc between Point D and Point E for a distance of 28 mm˜33 mm, the Horizontal Line N of the Center m of 2^{nd}. Arcuate Line from Point D to Point E connecting with 1^{st}. Arcuate Line is away from Vertical Extended Central Line Q of Link-Hole O for a distance of 26 mm˜58 mm, the Horizontal Central Line G of Heading-Hook is vertically apart from Central Line O of Link-Hole A by a distance of 26 mm˜58 mm; one End of a Spring with Oil-Rope inside is fixed on Place H of Heading-Hook, the other End is set into Spring Slot U, and Spring-guard Plate is fixed into Place U of Main Body. Due to reasonable coordination on designed measurement between Link-Hole A being eccentric from Arc Center of Jaw-Block and equitable linkage of the two (2) Arcuate Lines of Teeth Tips of Jaw-Block, which has made this invention with: Firm Self-Grip, as well as more Open-Width of Working Jaws; Heading-Hook is opened instantly being pressed on its Small Press-Button, putting it onto workpiece, the Working Jaws Grip firmly on workpiece while the Main Body is pushed, lifting Main Body to release quickly; the more pressure made on Main Body, the more tightness of locking will have; release is realized instantly while Main Body is lift up, the reliability of Grip is enhanced as well as more Open-Width and convenience.

The structure of the Pipe Wrench according to embodiments of the Invention has reasonable device on cooperative measurements between both of: Horizontal Line 0 of Link-Hole A and Tips of Arc-Shaped Jaw-Block, Center of Link-Hole A and Arc Centers of the Teeth on Jaw-Block, guaranteeing not only the Reliable Grip, but enlarged Open Width of Working Jaws. The damageable Jaw-Block is made of Alloy Steel to enhance its reliability and LifeTime. The Spring-Guard Plate that covered on top of Spring-Slot is to protect possible damages to the Spring; Oil-Rope is inserted into the hole of Spring for the Aim of Anti-Rust and enhancement of Life-Time and keeping fine tension, non-escape of workpiece, and made this kind of Pipe Wrench possible with Firm Grip at any position within its limits being operated and ample External-Force on workpiece. The Heading-Hook is opened quickly while being operated by pressing the Press-Button on Heading Hook, to place Pipe Wrench onto the workpiece, press Main Body, the Heading-Hook self grips firmly the workpiece; release is actualized by lifting up the Main Body lightly after operation, Quick and Flexible, Reliable and Convenient, Manpower-Save and Time-Save, High Efficiency.

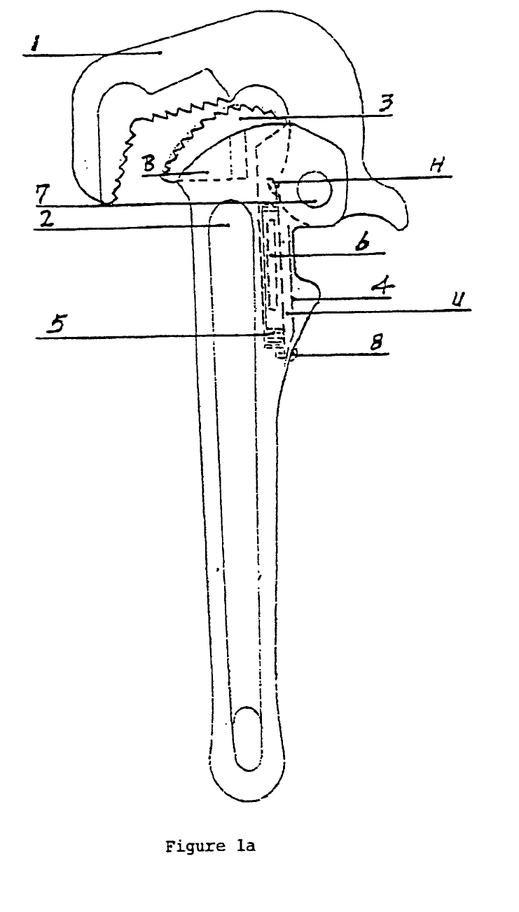

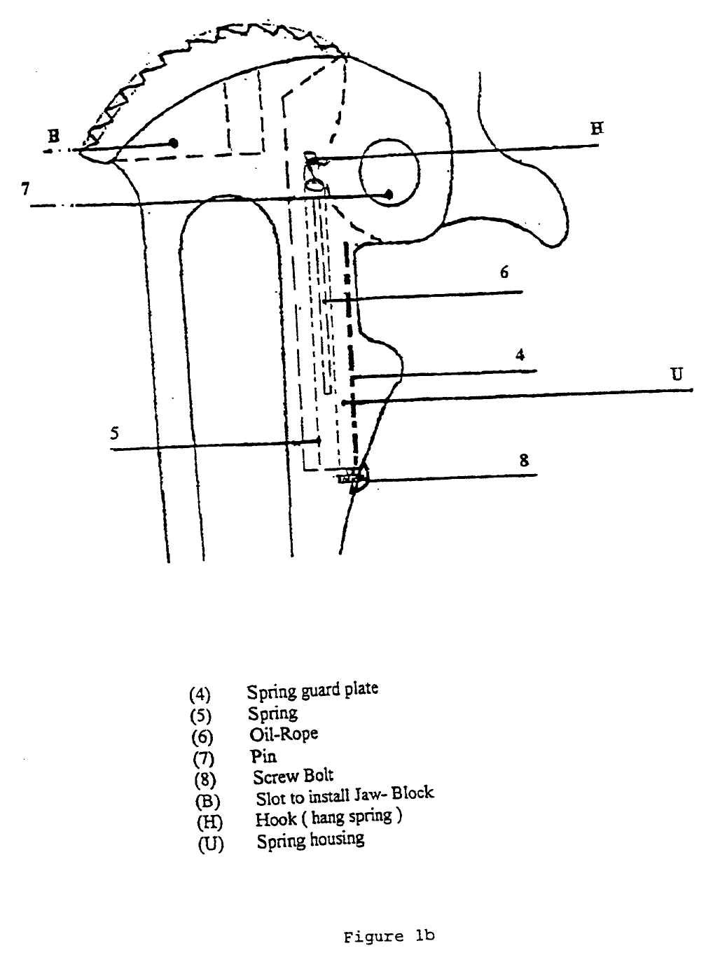

Within FIGS. 1a and 1b: (1) Heading-Hook; (2) Main Body; (3) Arcuate Jaw-Block; (4) Spring-Guard Plate; (5) Spring; (6) Oil-Rope; (7) Pin; (8) Screw Bolt;

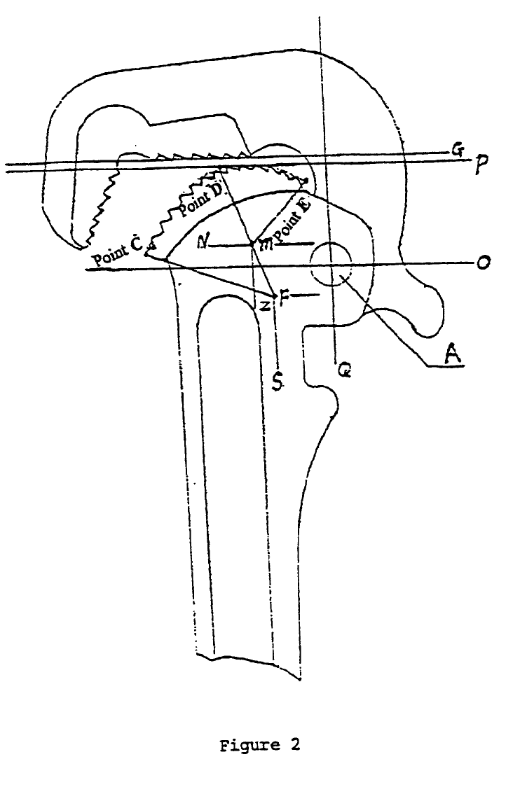

Within FIG. 2: (A) Link-Hole of Heading-Hook and Main Body; (B) Slot to fix Jaw-Block; (P) Horizontal Line of Teeth Tips on Arcuate Jaw-Block; (O) Horizontal Central Line of Link-Hole A; (Point C˜Point D) st. Arcuate Line of Jaw-Block; (Point D˜Point E) 2^{nd}. Arcuate Line connected with 1^{st}. Arcuate Line of Jaw-Block; (F) Center of 1^{st}. Arcuate Line of Jaw-Block; (S) Vertical Extended Line of Center of 1^{st}. Arcuate Line of Jaw-Block; (Q) Vertical Extended Line of Center of Link-Hole; (m) Center of 2^{nd}. Arcuate Line of Jaw-Block; (N) Horizontal Extended Line of Center of 2^{nd}. Arcuate Line of Jaw-Block; (G) Horizontal Central Line of Heading-Hook;

A Pipe Wrench according to a preferred embodiment of the invention is described hereinafter with reference to attached Figures: the Pipe Wrench is composed of: (1) Heading-Hook; (2) Main Body; (3) Arcuate Jaw-Block; (4) Spring-Guard Plate; (5) Spring; (6) Oil-rope; (7) Pin; (8) Screw Bolt; as illustrated in FIGS. 1a and 1b: the Heading-Hook is inlaid in/between Link-Point of Main Body, which is shaped as V Type with teeth arrayed on its inboard face and with an angle of 115°, and is connected by inserting one Pin into Link-Holes A both on Heading-Hook and Main Body; a Jaw-Block formed by two (2) different Arcuate Lines is inlaid into Slot B of Main Body, the vertical distance between Horizontal Line P of Tips of Jaw-Block and Horizontal Central Line O of Link-Hole A is of 27 mm; the Arc from Point C˜Point D has an angle of R23 mm, its Center-Point F and its Vertical Extended Line S is apart from Horizontal Central Line of Link-Hole A for 9 mm, the Central Point F of 1^{st}. Arcuate Line, on Jaw Block is away horizontally from Vertical Extended Line Q of Link-Hole A for a distance of 16 mm; the Vertical Extended Line N of Center m of the 2^{nd}. Arcuate Line from Point D˜Point E being connected with 1^{st}. Arcuate Line has a distance of 18 mm from Vertical Central Line Q of Link-Hole A, Horizontal Central Line G of Heading-Hook is away from Central Line O of Link-Hole A by 28 mm, one End of the Spring with Oil-Rope loaded inside is hang up on the Small Hook H, its other End is fixed into Spring Slot U on Main Body, the Spring-Guard Plate is fixed on Place U on Main Body by one screw bolt; due to above reasonable coordination on designed distances, reliability of grip is ensured, together with its enlarged Open-Width; the Heading-Hook is made of #20 Chrome Steel being forged or Precisely Cast Steeled, hardened after being machined partly; the Jaw-Block being inlaid on Main Body is made of #60 Alloy Steel with main ingredients of Silicon, Mn. and Mo., forged or pricelessly Cast Steeled, and to be quenched after being machined. This Invention of Pipe Wrench is with merits of: Wider Open-Width, Reliable Grip, Quick Self-Lock and Release, Time-Saving and Power-Saving easier operation.

1. A pipe wrench, comprising:
a main body for providing a handle;
a fixed jaw coupled to the main body, the fixed jaw being formed by at least two arcing jaw faces that are congruent and extend away from the main body;
an angled jaw pivotably coupled to the main body for interacting with the fixed jaw for clamping, the angled jaw having at least two substantially straight jaw faces which face the at least two arcing jaw faces at an angle to each other for providing a three-point grip in conjunction with the fixed jaw during clamping; and
a pivot disposed on the main body adjacent to the fixed jaw for pivotably coupling the angled jaw to the main body
wherein the angle is obtuse and the radius of the arcing jaw face arc proximal to the pivot is smaller than the arcing jaw face arc distal to the pivot.

2. The wrench as in claim 1, wherein the fixed jaw is removably coupled to the main body

3. The wrench as in claim 2, where the fixed jaw is removably coupled to the main body by being inserted into a slot in the main body.

4. The wrench as in any of the above claims, further including a biasing means for biasing the angled jaw towards the fixed jaw for clamping.

5. The wrench as in any of the above claims, wherein the jaw faces have gripping surfaces.

6. The wrench as in claim 5, wherein the gripping surfaces have teeth.

7. The wrench as in any of the above claims, wherein the longitudinal separation between the pivot and an extremity of the fixed jaw furthest away from the main body is 20 to 50 mm.

8. The wrench as in any of the above claims, wherein the longitudinal separation between the pivot and an extremity of the substantially straight jaw on the angled jaw proximal to the pivot nearest to the main body is 26 to 58 mm.

9. The wrench as in any of the above claims, wherein the longitudinal separation between the pivot and the center point of the larger arcing jaw face is 8 to 65 mm.

10. The wrench as in any of the above claims, wherein the transverse separation between the pivot and the center point of the larger arcing jaw face is 10 to 43 mm.

11. The wrench as in any of the above claims, wherein the longitudinal separation between the pivot and the center point of the smaller arcing jaw face is 2 to 33 mm.

12. The wrench as in any of the above claims, wherein the transverse separation between the pivot and the center point of the smaller arcing jaw face is 16 to 62 mm.

13. The wrench as in any of the above claims, wherein the angle of the larger arc jaw face is R30 to 120 mm.

14. The wrench as in claim 13, wherein the angle of the smaller arc jaw face is R20 to 90 mm.
